(19) United States
(12) Patent Application Publication
(10) Pub. No.: US 2005/0057802 A1
(43) Pub. Date: Mar. 17, 2005

(54) Building with roof mounted periscope

(76) Inventor: Allan V. Burman, Arlington, VA (US)

Correspondence Address: Roy N. Envall, Jr., 12223 Folkstone Dr, Oak Hill, VA, 20171, US

(21) Appl. No.: 10/843,445

(22) Filed: May 12, 2004

Related U.S. Application Data
(60) Provisional application No. 60/503,493, filed on Sep. 17, 2003.

(51) Int. Cl. G02B 23/08

(52) U.S. Cl. 359/402; 359/406

(57) ABSTRACT

A periscope is mounted through the roof and into a room within a building, such as a house or the like, whereby people in the building can view scenes outside without leaving the building. The periscope extends from a room in the building, such as a living room of a house, upwardly through any overhead ceilings and floors and through the roof. Further, the periscope extends above the topmost roofline for increased distance viewing or viewing over obstacles. Using en eyepiece at the bottom of the periscope, a user can then see outside areas, including distant areas, while remaining in the comfort of his or her house. The building can be any permanent dwelling structure such as a house, cabin, beach house or the like. Also, the periscope is vertically movable to raise the viewing height and rotatably mounted for full circle viewing.

This application is based upon, and claims priority to, Provisional Application for Patent No. 60/503,493, filed Sep. 17, 2003.

### BACKGROUND OF THE INVENTION

It has long been desired to be able to see extended or distant outside areas from within a building or dwelling. In the past these views have best been achieved from atop or on the roof of the building or house. For example, many coastal homes were constructed during the early sailing or seafaring era with roof mounted or raised platforms or balconies (“widow walks”) whereby distant views of the ocean and ships thereon or surrounding areas could be achieved. These roof-mounted platforms, however, are expensive to build and are difficult to reach due to their location on the roof of the house. Further, their viewing advantage was limited to the height of the roof and they were usable only in calm, dry weather.

The prior art shows examples of periscopes in children's toy apparatus. For example U.S. Pat. No. 5,916,097 a child's play apparatus, which may include, but does not show, a periscope near the top thereof. U.S. Pat. No. 4,823,824 discloses a tent with a periscope. U.S. Pat. No. 3,660,951 discloses a shock shielding structure, which may include a periscope for exterior viewing in case of attack or war. None of these patents relate to permanent dwelling structures or buildings or to such structures with a periscope for exterior viewing.

### SUMMARY OF THE INVENTION

My invention, on the other hand, provides a raised viewing system for a permanently mounted or built structure such as a building or house or the like without resorting to building a viewing platform on the roof of the structure. In particular, I have invented the combination of a building or dwelling structure, such as a house or cabin, and a periscope mounted through the roof of the building or dwelling to extend from a room within the house to a height above the house roof. This allows viewing of surrounding sights from an increased height without the need to construct, or climb up to, a roof-mounted platform. Further, the periscope is usable in all types of weather and is adjustable in height thereby providing increased viewing options. Further, the periscope can have telescopic and/or wide-angle optics providing increased viewing options. The periscope is rotatably mounted for full circular area viewing around the dwelling site.

The roof-mounted periscope allows the building occupants to view distant areas around the building without having to venture outside or being exposed to inclement weather. Further, the roof-mounted periscope allows beach area building occupants the option of an “ocean view” even if their home is spaced back from the ocean or has other beach houses or sand dunes separating them from the beach.

The periscope is mounted substantially vertically through the roof of the building with the bottom or viewing eyepiece being preferably located in a common room of the building such as the living or family room. Also, the periscope would have a sliding, albeit weather tight, mounting mechanism through the roof of the house such that the periscope can be vertically raised or lowered as desired. The periscope is also horizontally rotatably mounted to allow full 360 degree viewing. Accordingly, users will be able a view from the house objects or general sea or landscapes areas from different heights and directions.

### BRIEF DESCRIPTION OF THE DRAWINGS

FIG. 1 is a view of a house, or the like, with the periscope protruding therefrom.

FIG. 2 shows a cutaway of the house with the periscope extending through the roof and down into a room of the house.

FIG. 3 shows an enlarged view of the periscope.

### DETAILED DESCRIPTION OF THE DRAWINGS

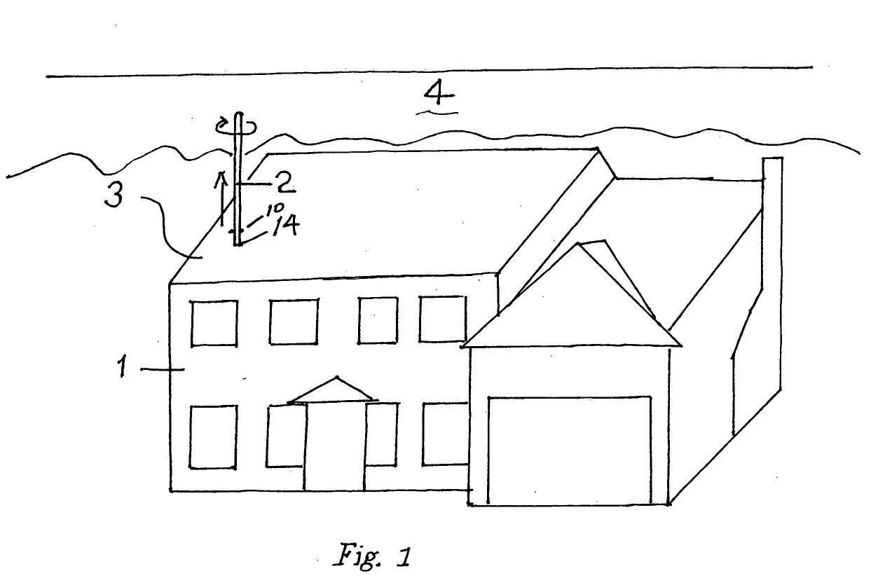

Referring to FIG. 1, the invention comprises the combination of a dwelling 1 such as a permanently mounted or built house, cabin or the like having a periscope 2 extending through roof 3. The house is shown near an ocean or the like 4. Flashing or seal 14, around the periscope where it passes through the roof, is to insure weather tight sealing between the roof and periscope. Means 10 are provided on casing 5 above the roof to limit downward movement of the periscope into the roof.

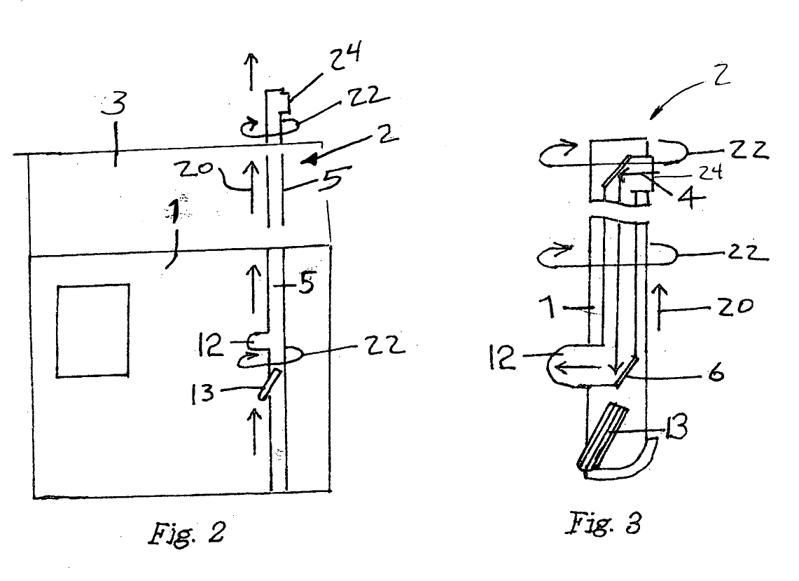

As shown in FIG. 2, the periscope includes tubular casing 5, which extends through flashing or seal 14 and is itself weather tight with the seal 14 as will be explained below. Furthermore, the periscope is movable vertically up or down through flashing or seal 14 as shown by arrows 20 and can rotate horizontally as shown by arrows 22. Periscope 2 may be raised and secured in a high position within the room to be out of the way when not in use. For example, tubular casing 5 may be constructed to telescope on itself when in the stored position.

The periscope, noting FIG. 3, includes tubular casing 5, internal mirrors 6 and 7 within casing 5, and an eyepiece 12 and an external lens 24 at opposite ends of casing 5. The two mirrors are mounted in the periscope at approximately 45 degrees from the vertical to allow substantially horizontal viewing through the periscope. The length of tubular casing 5 is chosen to allow the periscope to extend from a room in the house up and through the roof of the house. The length will also be sufficient to allow periscope 2 to extend through any intervening rooms or stories of the house (see FIG. 2). The bottom or eyepiece end of the periscope may include handles 13 to assist in rotating the periscope horizontally while being used. The handles also assist in raising the periscope up and out of the way when not in use. The upper mirror 7 and external lens 24 may be configured to allow wide angle viewing, if desired. The handles would also be used for focusing of the periscope optical system.

Thus, someone in the house, using the eyepiece end of the periscope is able see increased distant viewing from the house. The periscope height may be raised or lowered as desired as well as rotated for increased viewing options

1. In combination, a building having a roof and a periscope means mounted through said roof, said building consisting of solid building materials forming walls, at least one floor and said roof, said periscope means extending substantially vertically through said roof, said periscope means including a lower eyepiece end positioned within said building and an upper, exterior end extending through and to a position above said roof, whereby an occupant of said building can view the exterior area around said building from within said building structure using said periscope means.

2. The combination of claim 1, wherein said periscope means is vertically adjustable to change the lower eyepiece height position of said periscope means within said building and to also raise or lower the height of the exterior end of said periscope means above said roof.

3. The combination of claim 1, further comprising sealing means to seal said periscope means to said building as it extends through the roof of said building.

4. The combination of claim 1, further comprising means rotatably mounting said periscope means whereby the viewing area of said periscope means could encompass an arcuate or circular area.

5. The combination of claim 1, said building is a dwelling structure.

6. The combination of claim 1, wherein said building is selected from the group consisting of houses, cabins, cottages and the like.

7. The combination of claim 5, said dwelling structure consists of solidly built walls, floors, ceilings and a roof, whereby said periscope lower end extends into a room defined by said walls, floor and ceiling and extends up and through said roof.

8. In a dwelling structure, said dwelling structure consisting of floor means, wall means and roof means to form an enclosed structure, the improvement comprising a periscope and means mounting said periscope substantially vertically within the structure to extend from said room through said roof.

9. The invention of claim 8, said periscope consists of a hollow member having an eyepiece at one end thereof and a lens at the other end thereof, said eyepiece end being within said room and said other end being spaced above said roof.

10. The invention of claim 9, wherein said hollow member is tubular.

11. The invention of claim 8, further comprising means mounting said periscope for vertical movement through said roof.

12. The invention of claim 9, further comprising means mounting said periscope for vertical movement through said roof.

13. The invention of claim 10, further comprising means mounting said periscope for vertical movement through said roof.

14. The invention of claim 8, wherein said periscope is rotatably mounted to allow viewing in circular areas.

15. The invention of claim 8, wherein said dwelling structure is selected from the group consisting of houses, buildings, cabins, cottages or the like.

16. The invention of claim 10, means forming a watertight seal around said tubular member where it passes through said roof.
